(19) United States
(12) Patent Application Publication
(10) Pub. No.: US 2006/0162580 A1
(43) Pub. Date: Jul. 27, 2006

(54) Methods and apparatuses for cutting dough utilizing an insert or shaped plate

(76) Inventors: Stanley N. Lowry, Kernersville, NC (US); Garcie M. McCall, Germanton, NC (US)

Correspondence Address: J. Jason Link, Esq.;Kilpatrick Stockton LLP, 1001 West Fourth Street, Winston-Salem, NC, 27101, US

(21) Appl. No.: 11/227,755

(22) Filed: Sep. 15, 2005

Related U.S. Application Data
(60) Provisional application No. 60/609,929, filed on Sep. 15, 2004.

(51) Int. Cl. A47J 17/00

(52) U.S. Cl. 99/537

(57) ABSTRACT

Methods and apparatuses for cutting dough are described. In one embodiment, a dough cutter includes an inner tube, a shaped plate insert having a shaped plate and a shaft extending from the shaped plate insert, the shaped plate insert having a first end and a second end, the first end of the shaped plate insert adapted to couple to the inner tube, the second end of the shaped plate insert coupled to the shaped plate, and an outer tube having a first end and a second end, the first end of the outer tube adapted to slide over at least a portion of the inner tube and the second end of the outer tube defining a shaped opening for extruding dough, the shaped opening having substantially the same cross-section as the shaped plate. In some embodiments, the shaped plate may have a finite number of lines of symmetry.

### RELATED APPLICATIONS

This application claims priority to Application Ser. No. 60/609,929, filed on Sep. 15, 2004, titled “Methods and Apparatuses for Cutting Dough,” the entirety of which is incorporated herein by reference.

### FIELD OF THE INVENTION

The present invention relates generally to methods and apparatuses for cutting dough. More particularly, embodiments of the present invention relate to methods and apparatuses for cutting dough to form dough-based products having a variety of shapes.

### BACKGROUND OF THE INVENTION

Doughnut production involves mixing and extruding dough and then frying the dough. In some non-limiting processes, dough is cut and dropped onto a belt or tray and transported through a proofer to a frying apparatus. After frying, the dough-based product may be glazed, filled, and/or decorated to make the final doughnut. Other processes for making doughnuts are also known.

An apparatus for extruding dough is often referred to as an extruder. Typical extruders comprise a container for the dough, a lid with hold-down screws, and an extruding mechanism that dispenses the dough-based products at the base of the container. The dough is extruded and cut by an extruding mechanism.

A typical extruder is constructed somewhat like a pressure cooker, and the container is airtight when the screws are tightened and the lid is secured. Once secured, the container is pressurized to a pre-selected starting air pressure that is based on the type of dough-based product to be dispensed. Air pressure can be important to the maintenance of proper dispensed weight of the selected dough-based product. Next, the extrusion process is initiated and air pressure forces the dough through the cutters as they are opened and closed by the air cylinder mechanism. Examples of extruders are described in U.S. Pat. Nos. 6,511,689 and 6,511,309. U.S. Pat. No. 6,511,689 is hereby incorporated by reference.

Extruders are important in controlling the size and shape of dough-based products. Among other features and aspects, the extruders described in U.S. Pat. No. 6,511,689, assist in controlling the size of dough-based products. Among other features and aspects, dough cutters assist in controlling the shape of dough-based products.

For many dough-based products, the shapes of the products are uniform. For example, many doughnuts have generally uniform shapes. Doughnuts, such as ring doughnuts, doughnut shells, doughnut holes, and others, often have rounded, substantially uniform shapes.

Doughnuts and other dough-based products have traditionally been extruded and cut as substantially uniform shapes for a number of reasons. The extrusion and cutting of dough-based products having generally uniform shapes is believed to be easier than the extrusion and cutting of dough-based products having relatively complex and/or non-uniform shapes. For example, with substantially uniform dough-based products, the flow of dough through and out the dough cutters is generally consistent at all locations. As dough-based products have traditionally been extruded and cut as substantially uniform shapes, the production of dough-based products having relatively complex and/or non-uniform shapes could require the purchase and design of new dough cutters for each new shape, which could be expensive.

A need exists for manufacturers of dough-based products to be able to extrude and cut dough-based products having a variety of shapes. The ability to extrude and cut dough-based products having a variety of shapes could provide unique marketing opportunities to manufacturers and sellers of dough-based products. The various product shapes and designs available could intrigue consumers. For example, manufacturer and sellers of dough-based products might generate consumer interest by selling dough-based products in shapes associated with holidays, events, sports teams, locations, companies, cities, states, etc. A need also exists to be able to extrude and cut dough-based products having a variety of shapes in a manner that is cost-effective to the manufacturers and sellers of dough-based products.

### SUMMARY

Embodiments of the present invention include methods and apparatuses for cutting dough. In one embodiment, a dough cutter according the present invention comprises an inner tube, a shaped plate insert comprising a shaped plate and a shaft extending from the shaped plate insert, the shaped plate insert having a first end and a second end, the first end of the shaped plate insert adapted to couple to the inner tube, the second end of the shaped plate insert coupled to the shaped plate, and an outer tube having a first end and a second end, the first end of the outer tube adapted to slide over at least a portion of the inner tube and the second end of the outer tube defining a shaped opening for extruding dough, the shaped opening having substantially the same cross-section as the shaped plate. In some embodiments, the shaped plate may have a finite number of lines of symmetry.

These illustrative embodiments are mentioned not to limit or define the invention, but to provide examples to aid understanding thereof. Illustrative embodiments are discussed in the Detailed Description, and further description of the invention is provided there. Advantages offered by the various embodiments of the present invention may be further understood by examining this specification.

### FIGURES

These and other features, aspects, and advantages of the present invention are better understood when the following Detailed Description is read with reference to the accompanying drawings, wherein:

FIG. 1 is a perspective view of a ring cutter inner tube in one embodiment of the present invention;

FIG. 2 is a perspective view of a ring cutter outer tube in one embodiment of the present invention;

FIG. 3 is a cross section view of an inner tube of a ring cutter in one embodiment of the present invention;

FIG. 4 is a cross section view of an outer tube of a ring cutter in one embodiment of the present invention;

FIG. 5 is a cross section view of a shaped plate insert for creating doughnut holes in one embodiment of the present invention;

FIG. 6 is a perspective drawing of an inner tube and a shaped plate of a ring cutter in one embodiment of the present invention;

FIG. 7 is a perspective view of an outer tube 702 that can be used in some embodiments of ring cutters of the present invention; and

FIGS. 8 and 9 are cross section views illustrating the operation of one embodiment of a ring cutter according to the present invention.

### DETAILED DESCRIPTION

Embodiments of the present invention provide methods and apparatuses for cutting dough. More particularly, embodiments of the present invention relate to methods and apparatuses for cutting dough to form dough-based products having a variety of shapes. In one embodiment, a dough cutter according to the present invention comprises an inner tube, a shaped plate insert comprising a shaped plate and a shaft extending from the shaped plate insert, the shaft having a first end and a second end, the first end of the shaft adapted to couple to the inner tube, and an outer tube having a first end and a second end, the first end of the outer tube adapted to slide over at least a portion of the inner tube and the second end of the outer tube defining a shaped opening for extruding dough, the shaped opening having substantially the same cross section as the shaped plate.

Examples of dough-based products that may be formed using the methods and apparatuses of the present invention include, without limitation, doughnuts, ring doughnuts, and mini ring doughnuts. The doughnuts may be formed in various shapes, including, for example, rings, small rings, ribbons, stars, cartoon mice, and various other shapes.

The inner tubes of dough cutters according to some embodiments of the present invention are adapted to be coupled to a tank containing dough under pressure. The dough is extruded through the dough cutter under pressure. Because the dough or other product is extruded under pressure in many extruders, it is generally desirable to avoid opportunities for the dough to escape the cutter. Leaks in dough cutters can result in fluctuations in weight and shape of the extruded product.

### Introduction

In one embodiment of the present invention a ring cutter for cutting doughnuts comprises an inner tube and an outer tube. The inner tube is coupled to an inner tube insert. The inner tube insert may comprise various shapes. In one embodiment, the inner tube insert is in the shape of a cylinder. The walls of the cylinder comprise holes for creating doughnut holes.

In other embodiments, the inner tube insert comprises a shaped plate insert. The shaped plate insert comprises a shaped plate and a shaft. The outer tube has an opening on one end that has substantially the same cross section as the shaped plate.

The outer tube is adapted to fit over the inner tube and may be attached to an actuator that causes the outer tube to move in relation to the inner tube between a closed position and an open position. The inner tube may be attached to a dough extruder, configured to contain pressurized dough and extrude the dough under pressure. When the outer tube is in an open position, dough is extruded through the end of the inner tube and outer tube. When the outer tube is in a closed position, no dough is extruded.

The inner and outer tubes may comprise multiple subcomponents. For instance, the outer tube may comprise a base and a nozzle, which can be coupled together. In one embodiment, the base is steel, and the nozzle is an acetal resin, such as DuPont's Delrin®. In another embodiment, the base and the nozzle are both steel. The inner tube may comprise an inner tube base and a shaped plate insert, which can be coupled together. In one embodiment, the inner tube base is steel, and the shaped plate insert is an acetal resin. In another embodiment, the base and the shaped plate insert are both steel.

The shaped plate insert described herein may be made from various materials. For instance, in one embodiment, the shaped plate insert comprises steel. In another embodiment, the shaped plate insert comprises thermoplastic. For example, the shaped plate insert may comprise an acetal resin, such as an acetal copolymer. One acetal copolymer that may be used in an embodiment of the present invention is DuPont's Delrin® (www.Dupont.com). In another embodiment, the shaped plate insert comprises crystalline thermoplastic polyester. One crystalline thermoplastic polyester that may be used in an embodiment of the present invention is DuPont's Hytrel® (www.Dupont.com).

As used herein, “ring doughnuts” refer to doughnuts having a hollow center portion. While the term “ring” may suggest that the doughnuts are circular, it is to be understood that the term “ring doughnuts” as used herein also comprises non-circular doughnuts having a hollow center. Embodiments of dough cutters of the present invention used to extrude and cut ring doughnuts may also be referred to as “ring cutters.” Some embodiments of the present invention are directed to dough cutters for extruding and cutting dough into non-circular ring doughnuts.

This introduction is given to introduce the reader to the general subject matter of the application. By no means is the invention limited to such subject matter. Illustrative embodiments are described below.

### Ring Cutter with Shaped Plate Insert

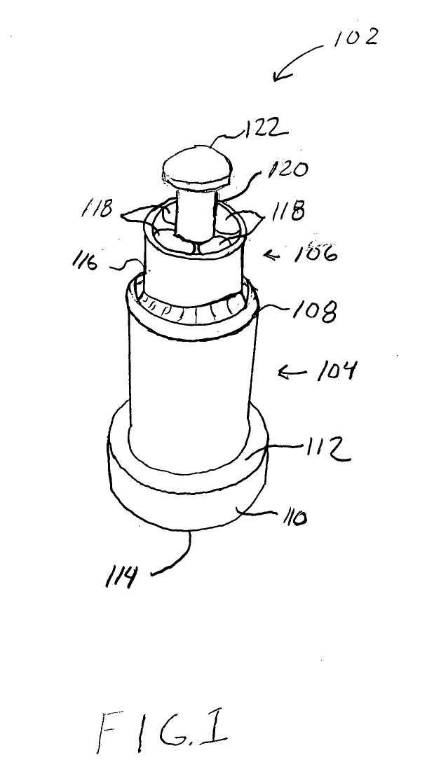

FIGS. 1-5 illustrate various embodiments of ring cutters or ring cutter components in some embodiments of the present invention. FIG. 1 is a perspective view of a ring cutter inner tube in one embodiment of the present invention. The ring cutter inner tube 102 shown comprises a ring cutter inner tube base 104. The ring cutter inner tube 102 is coupled to an inner tube insert 106. In the embodiment shown, the inner tube insert is a shaped plate insert 106.

The ring cutter inner tube base 104 and shaped plate insert 106 are joined at a seam 108. The base 104 and insert 106 may be joined in various ways. For example, in the embodiment shown, the base 104 and insert 106 are joined using two opposing protrusions on the inner portion of the base 104 near the seam 108 and two complementary grooves on the outer portion of the insert 106 near the seam 108. In another embodiment, the base 104 and insert 106 comprise complementary threads and are screwed together. An o-ring may be utilized on the inner tube to help prevent leaks. For example, the base 104 or insert 106 may comprise an o-ring at the seal to help prevent leaks at the seam 108.

Inner tube base 104 is adapted to be coupled at an end 110 opposite the seam 108 to a tank containing dough as described below. The base 104 is clamped to the tank at clamping area 114 and dough is extruded through the base 104 though an opening 114. The dough flows through the base 104 towards the seam 108 and the shaped plate insert 106.

In the insert 106, the dough flows through a lower portion 116 towards several holes 118 defined by structure supporting a shaft 120. Although described as a “lower” portion, in use, the inner tube is typically positioned so that the end 110 is at the top, proximate the tank, and the shaped plate insert 106 is at the bottom. Accordingly, the term “lower” does not limit the manner in which the inner tube or other aspects of the ring cutter are configured. The dough flows out of the holes 118 and around the shaft 120. The shaft 120 supports a shaped plate 122. The dough flows around the shaped plate 122. The shape of the plate 122 determines the shape of the dough product produced by the ring cutter. The length of the shaped plate insert 106 may be varied depending on the shape and size of doughnut to be produced. Also, the relationship between the shaped plate 122 and the shape plate opening (described below) may be varied to vary the shape and size of the doughnut to be produced.

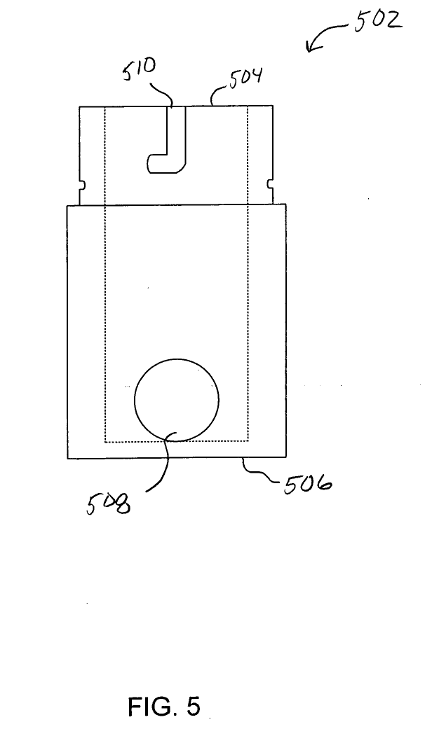

For example, in the embodiment shown in FIG. 1, a standard ring doughnut is formed. In other embodiments, the shaped plate 122 may comprise various other shapes for producing various shapes of doughnuts. Also, in some embodiments, the shaped plate may comprise a cylinder extending to the lower portion 116 of the shaped pate insert 106. Some such embodiments do not include a shaft. For instance, in the embodiment described below in relation to FIG. 5, the shaped plate insert does not include a shaft.

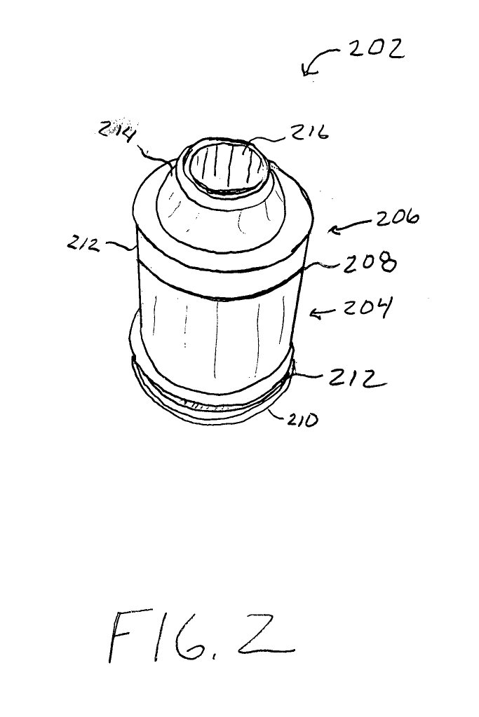

FIG. 2 is a perspective view of a ring cutter outer tube in one embodiment of the present invention. The outer tube 202 shown in FIG. 2 is configured to fit around the inner tube 102 shown in FIG. 1. The outer tube 202 comprises an outer tube base 204 and an outer tube nozzle 206.

The base 204 and nozzle are joined at a seam 208. The base 204 and nozzle 206 may be joined in various ways. For example, in the embodiment shown, the base 204 and nozzle 206 are joined using two opposing protrusions on the inner portion of the base 204 near the seam 208 and two complementary grooves on the outer portion of the nozzle 206 near the seam 208. In another embodiment, the base 204 and nozzle 206 comprise complementary threads and are screwed together. An o-ring may be utilized on the inner tube to help prevent leaks. For example, the base 204 or nozzle 206 may comprise an o-ring at the seal to help prevent leaks at the seam 208.

The outer tube base 204 comprises an end opposite 210 opposite the seam 208. Near the end 210, the base 204 comprises an actuator groove 212. The actuator groove 212 may be used to couple the outer tube 202 to an actuator (not shown) to move the outer tube 202 in relation to the inner tube 204. In one such embodiment, the inner tube 102 is held in a fixed position proximate a tank containing dough. An actuator moves the outer tube 202 down to dispense dough and back to stop the flow of dough. The outer tube 202 also comprises an opening 210 in which the inner tube 102 fits and through at least a portion of which dough flows.

The nozzle 206 of the outer tube 202 comprises a lower portion 212 and an upper portion 214. The upper portion 214 defines an opening 216. When dough flows out of the inner tube 102 and into the outer tube 202, it is dispensed onto a tray or conveyer through the opening 216 in the outer tube. The opening 216 in the outer tube 202 may have the same cross section as the shaped pate 122 of the inner tube. In some embodiments, the size of the inner surface of the opening, e.g., the inner circumference of the round opening 216 shown in FIG. 2, and size of the shaped plate, e.g., the outer circumference of the shaped plate 122 shown in FIG. 1, are substantially equal. Such an embodiment helps to prevent dough from leaking when the ring cutter is in a closed position.

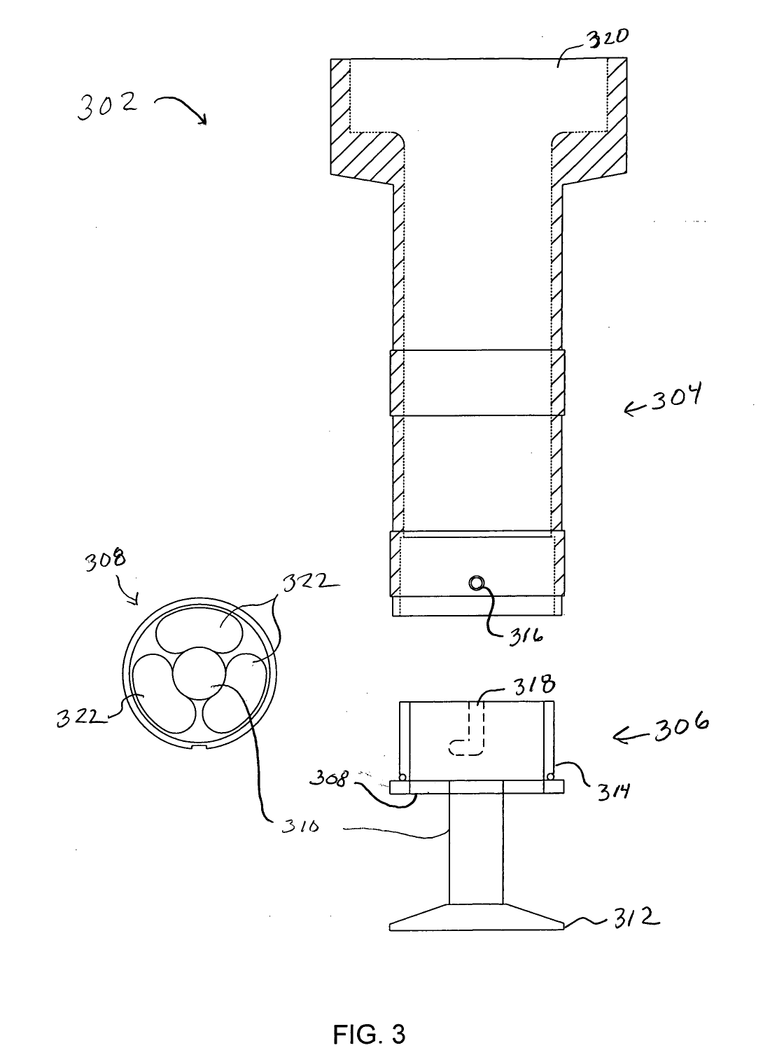

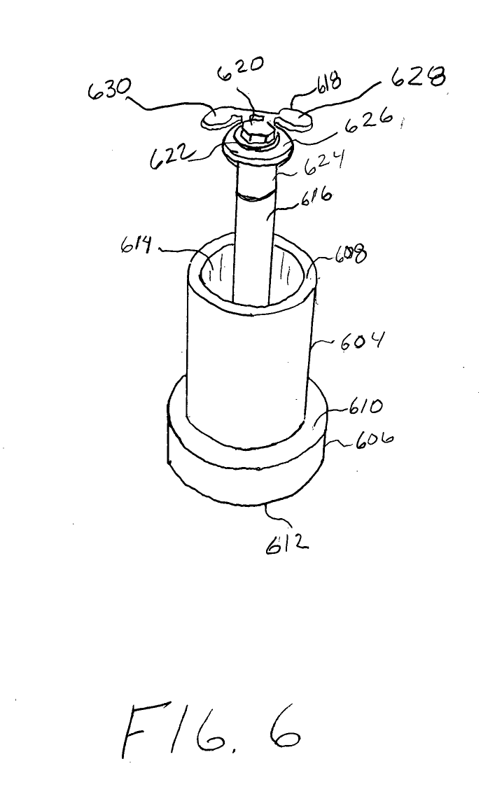

FIG. 3 is a cross section view of an inner tube of a ring cutter in one embodiment of the present invention. The embodiment shown comprises a base 304, and a shaped plate insert 306. Also shown in FIG. 3 is the support 308 for the shaft 310 and shaped plate 312. In the embodiment shown, the shaft 310, shaped plate 312, and lower portion 314 of the shaped plate insert 316 are formed from a single piece of thermoplastic. In other embodiments, the shaped plate insert may be formed from other materials such as steel. In still other embodiments, the shaft 310, shaped plate 312, and lower portion 314 of the shaped plate insert 316 may be formed separately and then joined together or coupled in some other way with the base 304, for example, in the embodiment shown in FIG. 6, the shaped plate is attached to the shaft with a bolt, the shaft is welded to the base, and the lower portion of the shaped plate insert is omitted.

In the embodiment shown in FIG. 3, the base 304 of the inner tube 312 comprises a projection 316 on the inner portion of the base 304. The projection may also be referred to as a pin. The insert 306 comprises a complementary groove 318 on the inner portion of the insert 306. The groove may also be referred to as a notch. The base 304 and insert 306 are joined by inserting the insert 306 into the base 304 and twisting. In some embodiments, the base 304 and insert 306 comprise a plurality of complementary projections and grooves. In other embodiments, the base 304 and insert 306 are joined by other means, such as, for example, complementary threads that allow the base 304 and insert 306 to be screwed together.

In use, dough flows from a tank (not shown) through an opening 320 in the base 304. It flows through the base 304 and into the lower portion 314 of the shaped plate insert 314. The dough then flows through holes 322 in the shaft support 308 and around the shaft 310 and shaped plate 312.

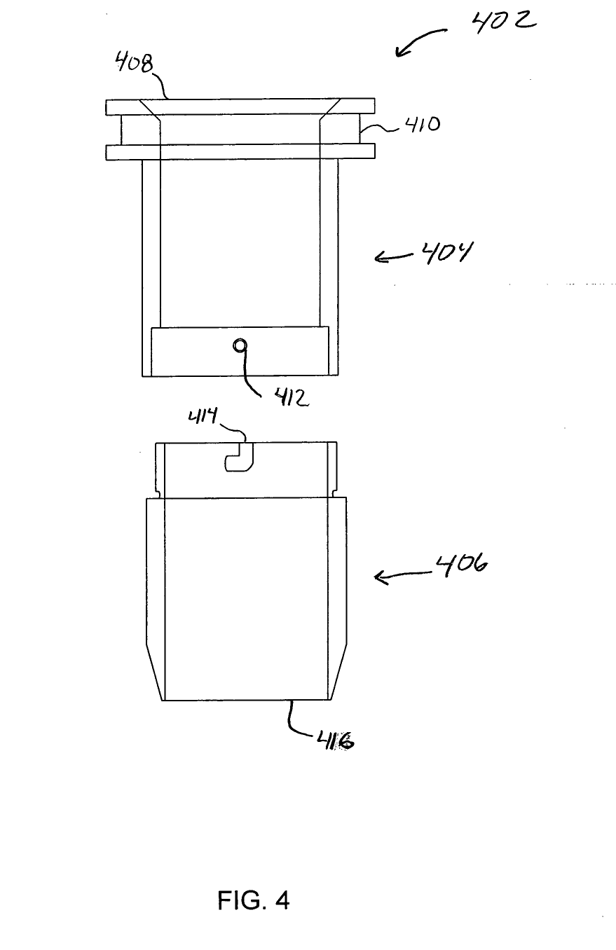

FIG. 4 is a cross section view of an outer tube of a ring cutter in one embodiment of the present invention. In the embodiment shown, the ring cutter outer tube 402 comprises a base 304 and a nozzle 306.

The base 404 of the outer tube 402 comprises an opening 408 adapted to fit around an inner tube. The base also comprises an actuator groove 410 for coupling an actuator to the outer tube. The base 404 also comprises a projection 412 on the inner portion of the base.

In the embodiment shown, the nozzle 406 comprises a groove 414, complementary to the projection 412 in the base. The base 404 and nozzle 406 are joined by inserting the nozzle 406 into the base 404 and twisting. In some embodiments, the base 404 and nozzle 406 comprise a plurality of complementary projections and grooves. In other embodiments, the base 404 and nozzle 406 are joined by other means, such as, for example, complementary threads that allow the base 404 and nozzle 406 to be screwed together.

The nozzle 406 also comprises an opening 416 through which dough passes. The opening 416 in some embodiments has the same cross section as the shaped plate of the inner tube over which the outer tube 402 fits.

### Shaped Plate Insert for Making Doughnut Holes

In the embodiments shown in FIG. 1-4, the inner tube insert comprises a round shaped plate. Such a plate may be used to create conventional ring doughnuts. Other types of inner tube inserts may be utilized in an embodiment of the present invention. FIG. 5 is a cross section view of an inner tube insert for creating doughnut holes in one embodiment of the present invention. A doughnut hole is a dough-based product formed in the shape of a small sphere. In a process of making doughnuts in which a round piece of dough is cut into a doughnut, the doughnut hole may be created as a by-product of the cutting process. When a ring doughnut is extruded through a conventional ring cutter, no by-product is created. Thus, a doughnut hole in such a process may be created through a separate process.

In the embodiment shown in FIG. 5, dough flows into the inner tube insert 502 through an opening 504 at one end of the inner tube insert 502. The dough flows towards a second end 506 of the inner tube insert 502. The second end of the inner tube insert is solid; dough cannot flow through the second end 506.

On the exterior wall of the inner tube insert 502 is a hole 508. As dough flows through the inner tube insert 502, it is forced through the hole 508 to create a doughnut hole. Although only one hole is illustrated in FIG. 5, such an embodiment may comprise a plurality of holes along the exterior wall of the inner tube insert 502. For instance, in one embodiment, three holes are present at equidistant points along the outer wall of the inner tube insert 502.

The inner tube insert 502 shown in FIG. 5 also comprises a groove 510. The groove 502 is used to couple the inner tube insert 502 with an inner tube base, such as those depicted in FIGS. 1 and 3. Various other types of shaped plate inserts may be used in an embodiment of the present invention. FIG. 5 is merely illustrative of one shaped plate insert.

### Shaped Plate Having a Finite Number of Lines of Symmetry

FIG. 6 is a perspective drawing of an inner tube and a shaped plate of a ring cutter in one embodiment of the present invention. The embodiment shown in FIG. 6 comprises an inner tube 604, a shaft 616, and a shaped plate 618. In the embodiment shown, the shaped plate 618 is coupled to a shaped plate shaft 624. The shaped plate shaft 624 is removably coupled to the shaft 616 by a bolt 620. A washer 622 is provided in the embodiment shown to reduce wear on the shaped plate 618 when the bolt 620 is tightened. In other embodiments, a shaped plate can be removably coupled directly to a shaft (e.g., shaft 616), such that a shaped plate shaft is not utilized.

In some embodiments, the cross-section of a shaped plate used in a dough cutter can have a finite number of lines of symmetry. For example in some embodiments, the shaped plate has one or two lines of symmetry. In some embodiments, the cross-section of the shaped plate can have one line of symmetry. In other embodiments, the cross-section of the shaped plate can have no lines of symmetry. A line of symmetry is present when a straight line across the cross-section of the shaped plate would divide the shaped plate into two symmetrical portions. For example, a rectangle has two lines of symmetry. A circle has many lines of symmetry, as any line across the diameter of the circle would be a line of symmetry. An isosceles triangle has one line of symmetry, while a scalene triangle has no lines of symmetry. Embodiments of dough cutters of the present invention that utilize shaped plates having two or less lines of symmetry further illustrate advantages of the present invention relating to the ability to form dough-based products having unique shapes.

The shaft 616 is positioned within the inner tube 604. A shaft can be coupled to an inner tube in a number of ways. In selecting a method for coupling a shaft to an inner tube, one consideration is to avoid selecting a method that would block the flow of dough through the inner tube or otherwise affect the flow of dough in a manner that would result in extruded and cut dough-based products having undesired sizes or shapes.

In the embodiment shown, the inner tube 604 is provided with a bar near the end 606. The end of the shaft furthest from the shaped plate 618 is coupled to the bar. In some embodiments, the end of the shaft may be welded to the bar. In other embodiments, a bolt or threaded cylinder can be provided on the bar and the end of the shaft can also be threaded to allow the shaft to be screwed onto bolt or threaded cylinder. An end of a shaft can be coupled to a bar in other ways known to those of skill in the art. One consideration in determining how to couple the shaft to the bar is that it can be desirable to couple the shaft in a manner that positions the shaft substantially in the center of the inner tube and to maintain that position during use of the dough cutter.

In the embodiment shown, the shaft 616 is coupled to the bar by welding. The shaft 616 is positioned substantially in the center of inner tube 604. The positioning of the shaft 616 substantially in the center of the inner tube can be important in producing ring doughnuts having a hollow center portion according to some embodiments of the present invention where the dough is extruded around a shaped plate. The shaft can be positioned off-center in the tube in some embodiments (e.g., if more/less dough is desired on certain portions of the extruded and cut dough-based products). One potential downside of positioning the shaft in a unique position for each style of dough cutter is an increase in capital costs since each style of dough cutter would need a separate shaft and possibly separate inner tubes and bars.

The embodiment shown in FIG. 6 utilizes a single shaft 616, and the dough cutter can be used to extrude and cut dough-based products having different shapes by only changing the shaped plate shaft 624. In other embodiments, a shaped plate can be coupled directly to a shaft, so that the dough cutter can be utilized to produce a dough-based product having a different shape by changing the shaped plate. The outer tube may also be changed in order for the shaped opening to correspond to the shaped plate when different shapes are to be extruded and cut.

The inner tube 604 shown in FIG. 6 comprises a clamping area 610. The inner tube 604 also comprises an opening 612 at a first end 606. The inner tube 604 is hollow so that dough passes from the opening 612 to the other end 608 of the inner tube 604, passing out of the opening 614 at the other end 608.

The shaped plate 618 is designed to extrude and cut dough-based ring products having the shape of a head of a cartoon mouse. The shaped plate 618 in this embodiment includes a face portion 626 and two ear portions 628, 630. When extruding dough, the dough extrudes around the shaped plate 618 and forms a doughnut ring having a shape similar to the head of a cartoon mouse.

The shaped plate 618 is permanently coupled to the shaped plate shaft 624 in this embodiment. An annulus passes through the shaped plate 618 and the shaped plate shaft 624 to assist in securing the shaped plate 618 and shaped plate shaft 624 to the shaft 616. The bolt 620 passes through the annulus to secure the shaped plate shaft 624 to the shaft 616.

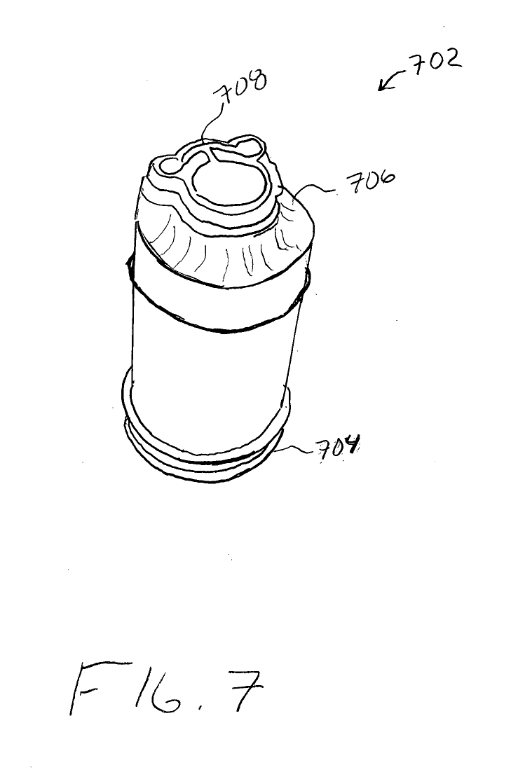

The shaped plate 618 and shaped plate shaft 624 are adapted to slide within an outer tube to extrude and cut dough-based products. Embodiments of outer tubes, such as the outer tube discussed below in connection with FIG. 7, can be provided with a slot within which the shaped plate 618 and shaped plate shaft 624 can slide. In the embodiment, a shaped plate shaft guide is provided to guide the movement of the shaped plate 618 and the shaped plate shaft 624. For example, the shaped plate shaft guide assists in keeping the shaped plate 618 aligned with a shaped opening in an outer tube.

In some embodiments, the shaped plate 618 and shaped plate shaft 624 can comprise other features to better produce a desired shape of dough-based ring products. For example, the thickness of the shaped plate 618 can be selected to control the amount of dough that is extruded for a particular product. In some embodiments, the shaped plate 618 can be machined to the desired thickness. In the embodiment shown, the thickness of the shaped plate 618 was increased after the shaped plate 618 was originally machined. The size and shape of a shaped plate and a shaped plate shaft can affect the size and shape of the dough-based products that are extruded and cut using the dough cutters, as will be discussed in more detail below.

Various shaft designs may be utilized in embodiments of the present invention. For instance, in one embodiment, the end of the shaft 616 to which the shaped plate 618 and shaped plate shaft 624 are coupled includes a portion having a narrower diameter than the remainder of the shaft. The shaped plate shaft 624 can slide over the narrow portion of the shaft and can be secured to the shaft 616 using a bolt 620 as shown in FIG. 6. The use of a shaft with a narrow portion for a shaped plate shaft to slide upon can provide more stability to the shaped plate shaft (e.g., the shaped plate shaft is less likely to sway vertically during use) and can allow the shaped plate shaft to have an outer diameter that is the same as the outer diameter of the remainder of the shaft.

FIG. 7 is a perspective view of an outer tube 702 that can be used in some embodiments of ring cutters of the present invention. A first end 704 of the outer tuber 702 is adapted to slide over at least a portion of an inner tube, such as the inner tube 604 shown in FIG. 6. A second end 706 of the outer tube 702 comprises a shaped opening 708. Dough can be extruded through the shaped opening 708 and cut to form a dough-based ring product having a desired shape.

The shaped opening 708 of the outer tube has the same cross-sectional shape as the shaped plate 618. The shaped plate 618 can slide into and out of the shaped opening 708 as the outer tube 702 moves relative to the inner tube 604, the shaft 616, and the shaped plate 618.

In the embodiment shown, the shaped opening 708 has a depth within which the shaped plate 618 can move. The shaped opening 708 can be tapered in some embodiments such that the cross-sectional area of the shaped opening 708 is smaller at the second end 706 of the outer tube 702 than the cross-sectional area of the portion of the shaped opening 708 on the interior of the outer tube 702. As described below, dough is pushed through the shaped opening and extruded into the desired shape.

### Operation of a Ring Cutter

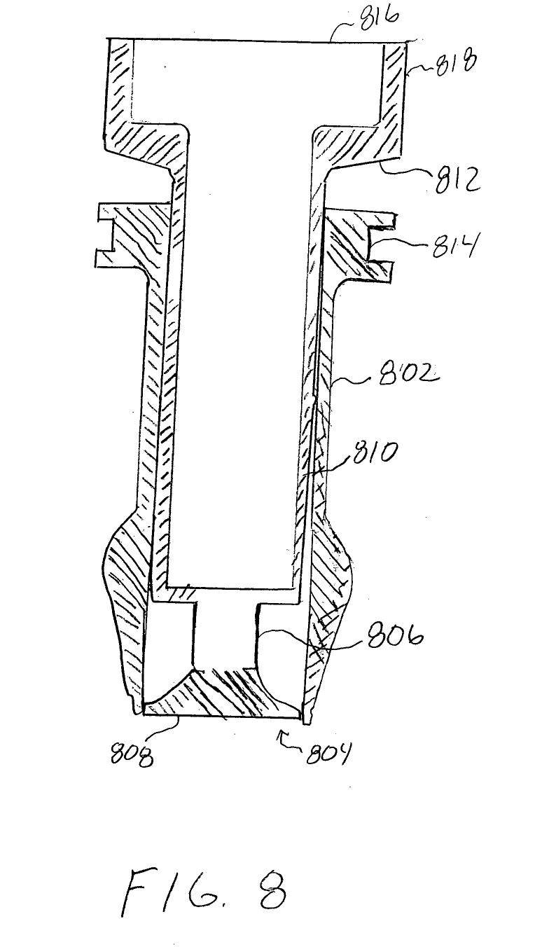

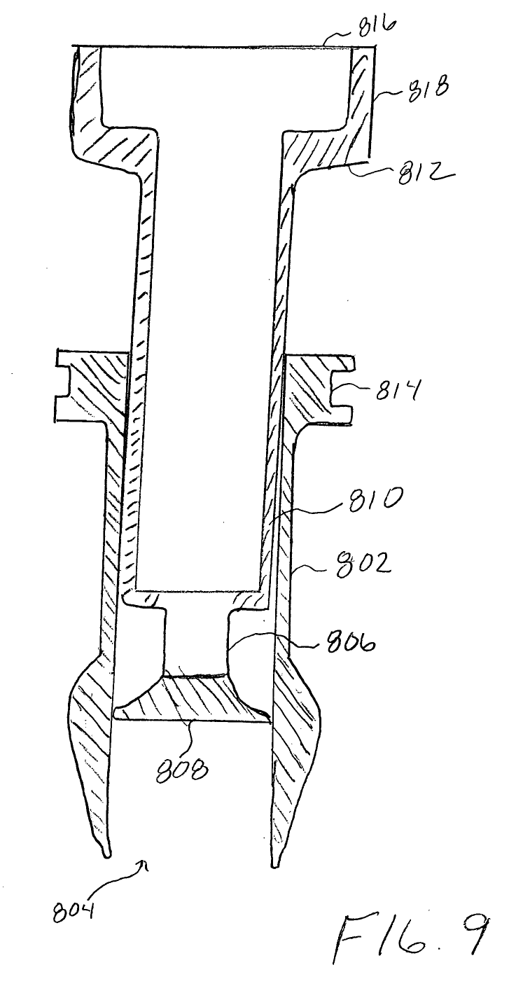

FIGS. 8 and 9 are cross section views illustrating the operation of one embodiment of a ring cutter according to the present invention. The embodiment shown in FIGS. 8 and 9 includes an outer tube 802 having a shaped opening 804, a shaped plate insert 806, a shaped plate 808, and an inner tube 810. In operation, the outer tube 802 moves relative to the inner tube 810, which remains stationary. The inner tube includes a clamp area 812, which allows the ring cutter to be clamped to an extruder as discussed below. The outer tube 802 comprises an actuator groove 814 near one of its ends. An actuator grip can be coupled to the outer tube 802 at the actuator groove 814. The movement of the actuator grip will move the outer tube 802. The outer tube 802 can be slid over at least a portion of the inner tube 810 using the actuator groove 814 and the actuator grip. An actuator grip or a plurality of actuator grips are typically components of an extruder apparatus, such as the one described in U.S. Pat. No. 6,511,689. In many extruder apparatuses, a plurality of dough cutters is gauged together by a single actuator grip and is actuated by a single air cylinder.

FIGS. 8 and 9 illustrate the interaction between outer tube 802 and the inner tube 810 as they can be positioned relative to one another in the extrusion and cutting of dough-based products. In FIG. 9, the ring cutter is shown in an “open” position. In the open position, the shaped plate 808 is not covering the shaped opening 804. When the ring cutter is installed on an extruder and the outer tube 802 is in this position, dough can flow through the shaped opening 804. In the embodiment shown, the outer tube 802 is positioned adjacent the clamp area 812 when the ring cutter is in the open position. When installed, as discussed below, a clamp from an extruder may be positioned between the outer tube 802 and the clamp area 812 to secure and seal the ring cutter to the extruder.

FIG. 8 shows the ring cutter in a “closed position”. In the closed position, the shaped plate 808 is blocking the shaped opening shaped opening 804. When the ring cutter is installed on an extruder and the shaped plate 808 is in this position, dough is not able to flow through the shaped opening 808. The movement of shaped plate 808 into the shaped opening 804 cuts the dough into a dough-based product. In the closed position, the outer tube 802 is positioned away from the clamp area 812 of the inner tube 810. When the outer tuber 802 begins sliding toward the clamp area 812 of the inner tube, the shaped opening 804 is slid away from the shaped plate 808, such that dough can be extruded through the shaped opening 808.

When this embodiment of a ring cutter is coupled with an extruder, the movement of the outer tube 802 between a position proximate the clamp area 812 of the inner tube 810 (or a position proximate a clamp from an extruder that seals the ring cutter to the extruder at the clamp area 812) and a position where the shaped plate 808 is positioned in the shaped opening 804 results in the extruding and cutting of dough. Dough is extruded through the shaped opening 804 when outer tube is positioned proximate the clamp area 812 (or proximate a clamp from an extruder), and the dough being extruded is cut when the shaped opening 804 slides over the shaped plate 808. The amount of time that the ring cutter remains open can affect the size of the dough-based product (e.g., the longer the ring cutter remains open, the larger the dough-based product).

In FIGS. 1, 2, 6, and 7, the ring cutter is shown with the shaped opening pointing upward. The ring cutter is oriented in this manner to better show its different features. In use, the ring cutter would typically be positioned with the shaped opening pointing generally downward in order to utilize gravity in extruding the dough. When the ring cutter is oriented with the shaped opening pointing generally downward, the extruded and cut dough can drop from the ring cutter onto a tray, a conveyor, or other surface.

To orient the ring cutter with the shaped opening pointing generally downward, the ring cutter can be positioned at the bottom of an extruder tank. U.S. Pat. No. 6,511,689 illustrates in FIG. 2 how dough cutters (referred to as extruding mechanisms 25 in the '689 patent) can be positioned relative to an extruder tank (referred to as tank 12 in the '689 patent). The dough leaving an extruder tank enters one end of the inner tube, travels through the inner tube and out the shaped opening. The ring cutter can be clamped into positioned at the bottom of the tank using the clamp area of the inner tube. A clamp or similar device can hold the inner tube between the clamp area and the actuator groove of the outer tube. For example, the clamp or similar device can form an annulus having a diameter that is larger than the diameter of the longest portion of the inner tube, but smaller than the diameter of the clamp area, such that the clamp area cannot slide through the annulus. The clamp can be positioned between the actuator groove of the outer tube and the clamp area, such that the outer tube does not rest against the clamp area.

The ring cutter can be sealed to the extruder tank at a seal area 816 of the inner tube 810 (illustrated in FIGS. 8 and 9). While the term sealed is used, it should be understood that the seal area 816 is positioned proximate to the bottom of the extruder tank in a manner that reduces the likelihood of dough or air escaping through a gap between seal area 816 and the extruder tank. If a pressurized tank is used to push the dough through the shaped opening 804, it can be important to maintain the pressure of the tank so that the desired weight of dough is extruded and cut. Thus, the connection between the ring cutter and the extruder tank can be important in the avoidance of leaks.

When installed on an extruder, the extruder can include a bung or similar protrusion that extends vertically downward from the extruder tank into the end 818 of the inner tube having the seal area 816. Dough can flow from a tank on the extruder through the bung and into the ring cutter. A clamp on the extruder can secure the inner tube 810 (and the entire ring cutter when assembled) to the extruder when it is tightened on the clamp area 812. The clamp seals the ring cutter to the extruder. An extruder can include a plurality of bungs or protrusions such that multiple ring cutters (e.g., one ring cutter for each bung or protrusion) can be installed.

An actuator grip from the extruder can be coupled to the actuator groove 814 on the ring cutter. For example, the actuator grip can be a u-shaped or horseshoe-shaped device that can slide into the actuator groove 814, such that vertical movement of the actuator grip can move the actuator groove 814, and accordingly the outer tube 802, upwardly or downwardly. The actuator grip, in some embodiments, can be coupled to a bar or shaft on the extruder that rotates to move the actuator grip. For example, the shaft can be oriented horizontally (e.g., the length of the shaft is horizontal), and the shaft can rotate on its horizontal axis. The actuator grip can be approximately perpendicular to the horizontal shaft such that rotation of the shaft in one direction moves the actuator grip (and hence the actuator groove 814 and outer tube 802) upward and rotation of the shaft in the opposite direction can move the actuator grip (and hence the actuator groove 814 and outer tube 802) downward. When multiple ring cutters are installed on the same extruder, an actuator grip associated with each ring cutter can also be coupled to the horizontal shaft. The horizontal shaft can move each of the outer tubes in unison so that the dough-based products from each ring cutter are extruded and cut at approximately the same time.

In some embodiments, when installed, the ring cutter can start in the closed position (e.g., with the shaped plate 808 positioned in the shaped opening 804). To extrude a dough-based product, the horizontal shaft rotates in one direction, which in turn moves the actuator grip and the outer tube 802 upward. The outer tube 802 moves toward the clamp area 812 of the inner tube 810, which results in the shaped plate 808 sliding out of the shaped opening 804 to allow dough to be extruded through the shaped opening 804. To cut the extruded dough, the horizontal shaft rotates in the opposite direction, which in turn moves the actuator grip and the outer tube 802 downward. The outer tube 802 moves away from the clamp area 812 of the inner tube 810, which results in the shaped opening 804 sliding over the shaped plate 808 to cut the extruded dough. In some embodiments, the ring cutter remains in the closed position when the extruder is not in operation.

While the above Figures illustrating embodiments of ring cutters relate to ring cutters for producing doughnut rings having the shape of the head of a cartoon mouse, a wide variety of shaped plates and shaped openings can be designed and used in embodiments of ring cutters of the present invention. The shaped plates and shaped openings shown in FIGS. 1-9 should not be viewed as limiting the present invention to a particular design or a particular shape of dough-based product. Shaped plates and shaped openings for the extrusion and cutting of dough-based ring products having other shapes can be designed based on the shaped openings shown and described herein. Ring cutters of the present invention can be designed with shaped plates and shaped opening to produce ring doughnuts in shapes associated with holidays, events, sports teams, locations, companies, cities, states, television programs, movies, characters, books, etc. For example, ring cutters can be designed to produce ring products in the shape of hearts, footballs, clovers (e.g., for St. Patrick's day), animals, fish, ribbons, cinnamon buns, etc.

Such dough-based ring products can also be decorated after extrusion, cutting, and cooking/frying. For example, the dough-based products can be at least partially coated with glaze(s), icing(s), sprinkle(s), and other toppings. For example, the dough-based ring products can be at least partially coated with icings having a color that is associated with the shape, an event, a team, a holiday, etc. For example, a heart-shaped dough-based ring product could be at least partially coated with white icing and with pink sprinkles or pink sugar.

As noted above, embodiments of ring cutters of the present invention can incorporate a wide variety of shaped plates and shaped openings depending on the desired shape of the dough-based product. Some embodiments of the present invention can facilitate the use of different shaped plates and shaped openings by making it easy to change shaped plates or shaped openings. For example, to change shaped openings in the embodiments shown and discussed above, a manufacturer of dough-based products would need to replace the entire outer tube to use a different shaped opening. Thus, a manufacture would need a different outer tube for each shape of dough-based product that it wanted to make. Some embodiments of the present invention can use outer tubes and inner tubes that are adapted to facilitate the changing of shaped openings and shaped plates.

In some embodiments, a ring cutter of the present invention can comprise an outer tube comprising an outer tube base and an outer tube nozzle, and can comprise an inner tube comprising an inner tube base and a shaped plate insert. The outer tube base and outer tube nozzle may be coupled to one another to form an outer tube. In some embodiments, the outer tube base and outer tube nozzle may each be threaded, such that the base and nozzle can be coupled by screwing the nozzle on the base. Similarly, the inner tube base and the shaped plate insert can be coupled to one another to form the inner tube. In some embodiments, the inner tube base and shaped plate insert may each be threaded, such that the base and shaped plate insert can be coupled by screwing the shaped plate insert on the base. The shaped plate insert can comprise a shaped plate, a shaft, and a threaded portion in some embodiments.

Shaped plates useful in embodiments of the present invention can be any number of shapes depending on the desired shape of the extruded and cut dough-based product. The shaped plate operates in the same manner as the shaped plates shown and described in connection with the embodiments shown in FIGS. 1-9. Shaped plate inserts having a variety of shaped plates can be designed and formed using techniques known to those of skill in the art, including by machining a piece of metal and by molding plastic. For example, the shaped plate inserts can be designed and formed to have shaped plates like any of those described above in connection with FIGS. 1-9.

Dough cutters of the present invention can be constructed from a number of materials. Because dough cutters are used in preparing food, the dough cutters are preferably constructed from food-grade materials. A number of food-grade materials can be used to construct dough cutters of the present invention including, without limitation, stainless steel, plastic, nylon, or other food-grade composites.

The components of embodiments of dough cutters of the present invention can be machined using an electrical discharging machining (EDM) system. Such systems are commercially available from Agie Ltd. of Lincolnshire, Ill. An example of a suitable EDM system is the Agiecut Classic 2S, commercially available from Agie Ltd. Similar technology, such as water jet cutting machines, can be used to make the components of dough cutters of the present invention. Such machines can precisely make the components, which can be important when machining dough cutters of the present invention designed to extrude and cut dough-based products having fairly complex shapes.

An EDM system can receive instructions for machining the components from a computer. For example, dough cutters can be designed using computer software, such as AUTOCAD from Autodesk, Inc., and the EDM system can receive the specifications from AUTOCAD and cut the various components of the dough cutters.

The thermoplastic components of embodiments of dough cutters of the present invention can be machined using a various cutting machines, such as a water jet cutting machine or a Computer Numerically Controlled (CNC) Bridgeport Series #2. Other types of suitable cutters may also be used.

After assembly and prior to use, a lubricant can be applied to dough cutters of the present invention. The lubricant can also be added during operation as needed to facilitate movement of the various components of the dough cutters. Lubricant can be applied to ring cutters and shell cutters of the present invention using techniques known to those of skill in the art. For example, lubricant can be sprayed on the dough cutters prior to use. The lubricants can be food-grade oil lubricants. An example of a lubricant useful in embodiments of the present invention is K-Lube Mineral Oil USP, which is available from Mallet & Company of Carnegie, Pa.

### General

The foregoing description of the embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

That which is claimed:

1. A dough cutter comprising:
an inner tube;
a shaped plate insert comprising a shaped plate and a shaft extending from the shaped plate insert, the shaped plate insert having a first end and a second end, the first end of the shaped plate insert adapted to couple to the inner tube, the second end of the shaped plate insert coupled to the shaped plate; and
an outer tube having a first end and a second end, the first end of the outer tube adapted to slide over at least a portion of the inner tube and the second end of the outer tube defining a shaped opening, the shaped opening having substantially the same shape as the shaped plate.

2. The dough cutter of claim 1, wherein the outer tube comprises:
an outer tube base; and
an outer tube nozzle adapted to couple with the outer tube base, the outer tube nozzle having a first end, defining the shaped opening.

3. The dough cutter of claim 2, wherein the outer tube nozzle comprises a thermoplastic.

4. The dough cutter of claim 2, wherein the outer tube nozzle comprises a metal.

5. The dough cutter of claim 2, wherein the outer tube base comprises at least one groove and the outer tube nozzle comprises at least one projection, the at least one groove and the at least one projection adapted to couple the outer tube base and the outer tube nozzle.

6. The dough cutter of claim 2, wherein the outer tube base comprises a first thread and the outer tube nozzle comprises a second thread complementary to the first thread and wherein the first thread and the second thread are adapted to couple the outer tube base and the outer tube nozzle.

7. The dough cutter of claim 1, wherein the inner tube comprises at least one groove and the shaped plate insert comprises at least one projection, the at least one groove and the at least one projection adapted to couple the inner tube and the shaped plate insert.

8. The dough cutter of claim 1, wherein the shaped plate is a removable shaped plate adapted to couple to the second end of the shaft.

9. The dough cutter of claim 1, wherein the shaped plate and the shaped opening are non-circular.

10. The dough cutter of claim 1, wherein the cross-section of the shaped plate comprises a finite number of lines of symmetry.

11. The dough cutter of claim 10, wherein the cross-section of the shaped plate comprises one line of symmetry.

12. The dough cutter of claim 1, wherein the cross-section of the shaped plate comprises zero lines of symmetry.

13. The dough cutter of claim 1, wherein the shaped plate insert comprises a metal.

14. The dough cutter of claim 1, wherein the shaped plate insert comprises a thermoplastic.

15. The dough cutter of claim 14, wherein the thermoplastic comprises an acetal resin.

16. The dough cutter of claim 15, wherein the acetal resin comprises an acetal copolymer.

17. The dough cutter of claim 14, wherein the thermoplastic comprises crystalline thermoplastic polyester.

18. The dough cutter of claim 1, wherein the shaped opening having substantially the same shape as the shaped plate comprises the shaped opening having substantially the same cross-sectional area as the shaped plate.

19. A dough cutter comprising:
an inner tube;
an inner tube insert, the inner tube insert having a first end and a second end, the first end of the inner tube insert adapted to couple to the inner tube; and
an outer tube having a first end and a second end, the first end of the outer tube adapted to slide over at least a portion of the inner tube and the second end of the outer tube defining a shaped opening for extruding dough.

20. The dough cutter of claim 19, wherein the inner tube insert comprises a cylinder having at least one hole defined by a surface of the cylinder, the hole adapted to form a doughnut hole.

21. The dough cutter of claim 19, wherein the inner tube insert comprises a shaped plate.

22. A dough cutter comprising:
an inner tube;
a shaped plate having a finite number of lines of symmetry;
a shaft extending from the shaped plate, the shaft having a first end and a second end, the first end of the shaft adapted to couple to the inner tube; and
an outer tube having a first end and a second end, the first end of the outer tube adapted to slide over at least a portion of the inner tube and the second end of the outer tube defining a shaped opening for extruding dough, the shaped opening having substantially the same shape as the shaped plate.

23. The dough cutter of claim 22, wherein the shaped opening having substantially the same shape as the shaped plate comprises the shaped opening having substantially the same cross-sectional area as the shaped plate.
